(19) United States
(12) Patent Application Publication
(10) Pub. No.: US 2022/0330613 A1
(43) Pub. Date: Oct. 20, 2022

(54) SHISHA DEVICE WITH DIELECTRIC HEATER

(71) Applicant: Philip Morris Products S.A., Neuchatel (CH)

(72) Inventors: Robert EMMETT, Neuchatel (CH); Ana Isabel GONZALEZ FLOREZ, Neuchatel (CH)

(73) Assignee: Philip Morris Products S.A., Neuchatel (CH)

(21) Appl. No.: 17/639,876

(22) PCT Filed: Sep. 1, 2020
(86) PCT No.: PCT/EP2020/074366

§ 371 Date: Mar. 2, 2022

(30) Foreign Application Priority Data
Sep. 3, 2019 (EP) 19195203.5

(51) Int. Cl. A24F 40/46; A24F 1/30; A24F 40/20; A24F 40/51; A24F 40/57

(52) U.S. Cl. CPC A24F 40/46; A24F 1/30; A24F 40/20; A24F 40/51; A24F 40/57

(57) ABSTRACT

A shisha device for heating an aerosol-forming substrate to generate an aerosol is provided, the shisha device including: a liquid cavity containing a volume of liquid through which aerosol generated by the shisha device is drawn before inhalation by a user, the liquid cavity having a head space outlet; an article cavity to receive the aerosol-forming substrate, the article cavity being in fluid communication with the liquid cavity; and an electromagnetic field generator to generate a radio frequency (RF) electromagnetic field in the article cavity, the electromagnetic field generator including a magnetron or a solid state RF transistor. A shisha system is also provided, including the shisha device and the aerosol-generating article. An aerosol-generating article for the shisha system is also provided.

This disclosure relates to a shisha system for generating an aerosol from an aerosol-forming substrate. In particular, this disclosure relates to a shisha system, a shisha device and a shisha article for use with a shisha device.

Traditional shisha devices are sometimes referred to in the art as a hookahs, qalyân, narghiles or water pipes. Traditional shisha devices are different to other aerosol-generating devices, in that volatile compounds released from a heated substrate in a shisha device are drawn through a liquid basin before inhalation by a user. Traditional shisha devices may include one outlet, or more than one outlet so that the device may be used by more than one user at a time.

Traditional shisha devices are typically used in combination with a shisha substrate, sometimes referred to in that art as hookah tobacco, tobacco molasses, or simply as molasses. Traditional shisha substrates are relatively high in sugar, in some cases comprising up to about 50 percent sugar, compared to about 20 percent which may be found in conventional combustible cigarettes.

Traditional shisha devices also employ charcoal to heat and sometimes combust the shisha substrate to generate an aerosol for inhalation by a user. Using charcoal to heat the shisha substrate may cause full or partial combustion of the tobacco and other ingredients in the shisha substrate.

Different types of electrically operated shisha systems have been proposed. Electrically operated shisha systems replace the charcoal heat source of a traditional shisha device with an electrically powered heater. Almost all proposed electrically operated shisha systems heat an aerosol-forming substrate by one or more of: conduction of heat from a heating element to an aerosol-forming substrate, radiation of heat from a heating element to an aerosol-forming substrate or drawing heated air through an aerosol-forming substrate. Most commonly, heating is achieved by passing an electrical current through an electrically resistive heating element, giving rise to Joule heating of the heating element. Inductive heating systems have also been proposed, in which Joule heating occurs as a result of eddy currents induced in a susceptor heating element.

One problem with previously proposed electrically operated shisha devices is that they may give rise to non-uniform heating of the aerosol-forming substrate. The portion of the aerosol-forming substrate closest to the heating element is heated more quickly or to a higher temperature than portions of the aerosol-forming substrate more remote from the heating element.

It would be desirable to be able to provide uniform heating of an aerosol-forming substrate in a manner that allows for greater design flexibility and that allows for heating control.

In this disclosure, there is provided a shisha device for heating an aerosol-forming substrate to generate an aerosol. The shisha device may comprise a liquid cavity configured to contain a volume of liquid. The liquid cavity may have a head space outlet. The shisha device may comprise an article cavity configured to receive an aerosol-forming substrate. The article cavity may be in fluid communication with the liquid cavity. The shisha device may comprise: an electromagnetic field generator configured to generate a radio frequency (RF) electromagnetic field in the article cavity.

In particular, in this disclosure there is provided a shisha device for heating an aerosol-forming substrate to generate an aerosol, the shisha device comprising: a liquid cavity configured to contain a volume of liquid, the liquid cavity having a head space outlet; an article cavity configured to receive an aerosol-forming substrate, the article cavity being in fluid communication with the liquid cavity; and an electromagnetic field generator configured to generate a radio frequency (RF) electromagnetic field in the article cavity.

Such a shisha device is configured to give rise to dielectric heating of the aerosol-forming substrate. Dielectric heating can be uniform within a volume of aerosol-forming substrate, without the creation of hot spots. Dielectric heating also requires no contact between a heating element and the aerosol-forming substrate. This means that there is no need to clean a heating element compared to conventional arrangements, where electrical heating elements which may suffer a build-up of aerosol residue on it. The shisha device allows for considerable design flexibility in terms of the shape, volume and composition of the aerosol-forming substrate and correspondingly the shape and volume of the article cavity.

The electromagnetic field generator may be any suitable type of electromagnetic field generator configured to generate a radio frequency (RF) electromagnetic field in the article cavity.

Preferably, the electromagnetic field generator comprises a solid state RF transistor.

The use of a solid state RF transistor allows the shisha device to be compact. The conventional means for producing RF frequency radiation for heating, such as in domestic microwave ovens, is a magnetron. Magnetrons are bulky and require high voltages to operate. Furthermore, magnetrons have a relatively unstable frequency output and have a relatively short service life. A RF transistor can provide for consistent operation over many more usage cycles and requires much lower operating voltages.

Advantageously, a solid state RF transistor may be configured to generate and amplify the RF electromagnetic field. Using a single transistor to provide both the generating and amplification of the RF electromagnetic field allows for a shish device to be compact. The solid state RF transistor may be, for example, a LDMOS transistor, a GaAs FET, a SiC MESFET or a GaN HFET.

Although it is preferable that the electromagnetic field generator comprises a solid state RF transistor, it is envisaged that in some embodiments the electromagnetic field generator may comprise a magnetron or other suitable electromagnetic field generator capable of generating a RF electromagnetic field.

As used herein, radio frequency (RF) means a frequency between about 3 hertz (Hz) and about 3 terahertz (THz). Accordingly, as used herein, RF frequencies include microwave frequencies. Preferably, the RF electromagnetic field has a frequency of between about 1 megahertz (MHz) and about 50 gigahertz (GHz). More preferably, the RF electromagnetic field has a frequency between about 4 megahertz (MHz) and about 30 gigahertz (GHz). The RF electromagnetic field may have a frequency of between about 100 megahertz (MHz) and about 10 gigahertz (GHz). In one embodiment the RF electromagnetic field has a frequency of about 4 megahertz (MHz). In one embodiment the RF electromagnetic field has a frequency of about 3 gigahertz (GHz). In one embodiment the RF electromagnetic field has a frequency of about 2.4 gigahertz (GHz).

As used herein, the term “aerosol-forming substrate” relates to a substrate capable of releasing volatile compounds that can form an aerosol. Such volatile compounds may be released by heating the aerosol-forming substrate. An aerosol-forming substrate is typically part of an aerosol-generating article. For example, an aerosol-forming substrate may be a shisha aerosol-forming substrate.

A shisha aerosol-forming substrate may also be referred to in the art as hookah tobacco, tobacco molasses, or simply as molasses. A shisha aerosol-forming substrate may be relatively high in sugar, compared to conventional combustible cigarettes or tobacco based consumable items intended to be heated without burning to simulate a smoking experience. The aerosol-forming substrate will later be described in more detail

As used herein, the term “aerosol-generating article” refers to an article comprising an aerosol-forming substrate that is capable of releasing volatile compounds that can form an aerosol. For example, an aerosol-generating article may be a cartridge for a shisha device. A cartridge for a shisha device comprises an aerosol-forming substrate. Preferably, a cartridge for a shisha device comprises a shisha aerosol-forming substrate. A cartridge for a shisha device is receivable by a shisha device and operable with the shisha device to generate an aerosol that is inhalable by a user drawing or puffing on a mouthpiece of the shisha device. An aerosol-generating article may be disposable.

As used herein, the term “shisha device” refers to a device that interacts with an aerosol-forming substrate to generate an aerosol. A shisha device is separate from an aerosol-forming substrate. A shisha device is configured for combination with an aerosol-forming substrate for heating the aerosol-forming substrate. The aerosol-forming substrate may be provided as part of an aerosol-generating article. A shisha device is separate from an aerosol-generating article. The shisha device is configured for combination with an aerosol-generating article for heating the aerosol-forming substrate of the aerosol-generating article. Shisha devices are different to other aerosol-generating devices, at least in that volatile compounds released from a heated substrate are drawn through a liquid basin of the shisha device before inhalation by a user. A shisha device may include more than one outlet so that the device may be used by more than one user at a time. A shisha device may comprise an airflow conduit, such as a stem pipe, for directing volatile compounds released from the aerosol-forming substrate to the liquid basin.

As used herein, the term “shisha system” refers to the combination of a shisha device with an aerosol-forming substrate or with an aerosol-generating article comprising an aerosol-forming substrate. In the shisha system, the aerosol-forming substrate or an aerosol-generating article comprising the aerosol-forming substrate and the shisha device cooperate to generate an aerosol.

A shisha device differs from other aerosol-generating devices in that the aerosol generated by a shisha device is drawn through a volume of liquid, typically water, before inhalation of the aerosol by a user. In more detail, when a user draws on a shisha device, volatile compounds released from a heated aerosol-forming substrate are drawn through an airflow conduit of the shisha device into a volume of liquid. The volatile compounds are drawn out of the volume of liquid into a headspace of the shisha device, in which the volatile compounds form an aerosol. The aerosol in the headspace is then drawn out of the headspace at a headspace outlet for inhalation by a user. The volume of liquid, typically water, acts to reduce the temperature of the volatile compounds, and may impart additional water content to the aerosol formed in the headspace of the shisha device. This process adds distinctive characteristics to the process of using a shisha device for a user, and imparts distinctive characteristics to the aerosol generated by the shisha device and inhaled by a user.

In some preferred embodiments, the shisha device comprises an airflow conduit for conveying volatilised compounds, released from a heated aerosol-forming substrate, from the article cavity to the liquid cavity. More specifically, the shisha device may comprise an airflow conduit configured to convey volatilised compounds, released from a heated aerosol-forming substrate, from the article cavity to a volume of liquid in the liquid cavity. Typically, the airflow conduit is configured to convey aerosol from the article cavity to below a liquid fill level in the liquid cavity. The liquid fill level in the liquid cavity is the level to which the liquid cavity is intended to be filled with liquid, such that the shisha device may be operated optimally. The airflow conduit may have an opening in the liquid cavity, below the liquid fill level of the liquid cavity.

The shisha device comprises a headspace outlet. The headspace outlet is an outlet through which aerosol may be drawn out of the liquid cavity. The headspace outlet may be arranged above the liquid fill level of the liquid cavity. The space above the liquid fill level of the liquid cavity is referred to as the headspace. The headspace in the liquid cavity is the space in which volatile compounds drawn from the article cavity and through the volume of liquid in the liquid cavity may condense to form an aerosol that is suitable for inhalation by a user. The headspace in the liquid cavity is not intended to comprise any of the volume of liquid in the liquid cavity. Accordingly, the headspace may be arranged above the liquid fill level of the liquid cavity, which is the level to which the liquid cavity is intended to be filled with liquid. The headspace outlet may be arranged to enable aerosol to be drawn from the liquid cavity. The headspace outlet may be in fluid communication with the headspace.

A mouthpiece may be fluidly connected to the headspace outlet. The mouthpiece may be configured for a user to draw on and receive aerosol generated by the shisha device. In some embodiments, the mouthpiece may be fixed to the headspace outlet. In other words, the mouthpiece may be attached to the headspace outlet such that the mouthpiece may not be removed from the headspace outlet without damaging one or both of the mouthpiece and the headspace outlet. The mouthpiece may be removably couplable to the headspace outlet. In other words, the mouthpiece may be configured to be attached to the headspace outlet and removed from the headspace outlet. In some embodiments, the mouthpiece may be interchangeable with a removable one wait air valve. In this way, where more than one headspace outlets are provided, the number of mouthpieces can be adjusted according to a number of users in any given usage session without adversely affecting the resistance to draw (RTD) of the device. The mouthpiece may comprise a hose connected to the headspace outlet. The hose may be a flexible hose.

The mouthpiece may include an activation element. The activation element may comprise a switch that is activatable by a user. The mouthpiece may comprise a puff sensor arranged to detect a user puffing on the mouthpiece. The activation element may comprise both a switch activatable by the user and a puff sensor. The activation element may be operably coupled to control circuitry of the shisha device. The activation element may be wirelessly coupled to control circuitry of the shisha device. Activation of the activation element may cause the control circuitry of the shisha device to activate the heating element, rather than constantly supplying power to the heating element. Accordingly, the use of an activation element may serve to save energy relative to devices not employing such elements to provide on-demand heating rather than constant heating.

The shisha device may comprise a plurality of headspace outlets. For example, the shisha device may comprise two, three, four, five or six headspace outlets. Providing more than one headspace outlet may enable more than one user to draw aerosol from the liquid cavity at a time. In other words, providing a plurality of headspace outlets may enable a plurality of users to use the shisha device simultaneously.

The shisha device comprises an article cavity configured to receive an aerosol-generating article comprising an aerosol-forming substrate.

It is desirable to contain the electromagnetic radiation generated by electromagnetic field generator within the article cavity. This is both to provide for efficient heating and to avoid radiation leakage. Such radiation leakage could be damaging to other components of the system, including the electromagnetic field generator itself. It is also desirable to minimise a user's exposure to RF radiation. Advantageously, the article cavity may comprise one or more external walls formed from a material opaque to the RF electromagnetic field. The one or more external walls of the article cavity may comprise any suitable material that is not transparent to RF radiation, such as aluminium, stainless steel, silver or gold. The one or more external walls of the article cavity may have a polished surface to improve reflection of the RF radiation within the cavity.

Radiation must also be allowed to enter the article cavity. Accordingly, one or more slots may be formed in the one or more external walls to allow for ingress of the electromagnetic field into the article cavity. Providing one or more slots through which the electromagnetic field can pass, allows the electromagnetic field to enter the article cavity. The one or more slots may have any suitable shape and size to allow the electromagnetic field to enter the article cavity. For example, at least one of the one or more slots may have an L-shape, an S-shape, a T-shape or an I-shape.

The article cavity may comprise one or more walls that are transparent to the RF electromagnetic field. In particular, the article cavity may comprise one or more walls that are transparent to the RF electromagnetic field where the aerosol-forming substrate is encased in a wrapper or container formed from a material opaque to the RF electromagnetic field. One or more slots may be formed in the wrapper or container encasing the aerosol-forming substrate to allow for ingress of the electromagnetic field.

The article cavity may have any suitable shape and size. In particular, the article cavity may have a shape and a size that is complementary to an aerosol-generating article.

The article cavity may have any suitable transverse cross-section. For example, the article cavity may have a circular, oval, rectangular, square, triangular or any other polygonal transverse cross-sectional shape.

In some embodiments, the article cavity is substantially cylindrical.

In some embodiments, the article cavity is substantially frustoconical. In some embodiments, the width or diameter of one end of the article cavity is greater than the width or diameter of the other end of the article cavity. In other words, the article cavity may be tapered from one end to the other end. Providing the article cavity with one end that is narrower than the other end may enable the article cavity to retain an aerosol-generating article in the article cavity under the influence of gravity alone.

The article cavity may comprise an opening. The article cavity may be configured to receive an aerosol-forming article containing the aerosol-forming substrate through the opening. The article cavity may comprise an open end. The article cavity may be configured to receive an aerosol-forming article containing the aerosol-forming substrate through the open end.

In some embodiments, the article cavity may comprise a moveable closure. The moveable closure may be configured to substantially close the open end of the article cavity. When the moveable closure is arranged to substantially close the open end of the article cavity, the moveable closure may substantially prevent an aerosol-forming article from being removable from the article cavity. The moveable closure may be rotatably moveable to close the open end of the article cavity. The moveable closure may be slidably moveable to close the open end of the article cavity. The moveable closure may be removably couplable to the open end of the article cavity to substantially close the open end of the article cavity.

In some embodiments, the article cavity may comprise two open ends. For example, the article cavity may comprise an open first end, and an open second end, opposite the first end. Advantageously, providing the article cavity with two open ends may enable air to be drawn through the article cavity, between the open ends.

In some embodiments, the article cavity may comprise an open end and a closed end. The closed end may enable the article cavity to retain an aerosol-generating article in the article cavity.

In some particularly preferred embodiments, the article cavity is substantially frustoconical, having a first end that is narrower than a second end. In these embodiments, the first end of the article cavity may be open and the second end of the article cavity may be open. This may enable air to be drawn through the article cavity, from the first end to the second end. In these embodiments, an aerosol-generating article configured to be received in the article cavity may comprise a fluid permeable first end external surface and a fluid permeable second end external surface. The fluid permeable first end and second end external surfaces of the aerosol-generating article may enable air to flow though the article cavity, between the first end and the second end, when the aerosol-generating article is received in the article cavity. In these embodiments, preferably the fluid permeable first end and second end external surfaces of the aerosol-generating article are opaque to the RF electromagnetic field. For example, the fluid permeable first end and second end external surfaces may be formed from a metal mesh.

The article cavity may have any suitable shape and dimensions. The article cavity may have a length of between about 10 millimetres and about 100 millimetres, between about 20 millimetres and about 90 millimetres or between about 25 millimetres and about 80 millimetres. In some preferred embodiments, the article cavity may have a length of about 33 millimetres, about 34 millimetres, about 35 millimetres, about 36 millimetres, about 37 millimetres, about 38 millimetres, 39 millimetres, about 40 millimetres, about 41 millimetres or about 42 millimetres. The article cavity may have a width or diameter of between about 5 millimetres and about 70 millimetres, or between about 10 millimetres and about 60 millimetres or between about 10 millimetres and about 50 millimetres. In some preferred embodiments, the article cavity may have a width or diameter of about 35 millimetres, about 36 millimetres, about 37 millimetres, about 38 millimetres, 39 millimetres, about 40 millimetres, about 41 millimetres, about 42 millimetres, about 43 millimetres, about 44 millimetres or about 45 millimetres.

As used herein, the term ‘length’ refers to the maximum longitudinal dimension between a base or bottom end and a top end of a shisha device, a component of the shisha device, an aerosol-generating article or a component of an aerosol-generating article. As used herein, the term ‘width’ or ‘diameter’ refers to the maximum transverse dimension of a shisha device, a component of the shisha device, an aerosol-generating article or a component of an aerosol-generating article. For example, where an aerosol-generating article has a frustoconical shape, the width or diameter of the aerosol-generating article is the width or diameter of the base of the frustoconical shape, which is the widest part of the aerosol-generating article at any point along the length of the aerosol-generating article. A transverse dimension is a dimension measured in a direction transverse to a longitudinal direction, the longitudinal direction being the direction in which longitudinal dimensions are measured. As used herein, the term ‘transverse cross-section’ refers to a cross-section taken along a transverse plane.

As used herein, the terms ‘top’ and ‘bottom’ refer to relative positions of elements, or portions of elements, of a shisha device, a component of the shisha device, an aerosol-generating article or a component of an aerosol-generating article.

The article cavity may be located in a heating unit. The heating unit may comprise the article cavity and the electromagnetic field generator. The heating unit may further comprise one or more of control circuitry, a power supply and electromagnetic field manipulators, such as waveguides and antennas, as described in more detail below. The heating unit may further comprise one or more electrical connectors for electrically connecting one or more electrical components to the heating unit, such as control circuitry, a power supply, and electromagnetic field manipulators.

The heating unit may comprise one or more external walls formed from a material opaque to the RF electromagnetic field. Preferably, all of the external walls of the heating unit are formed from material opaque to the RF electromagnetic field. The heating unit may comprise an opening to enable insertion of an aerosol-generating article into the article cavity. The heating unit may comprise a movable closure, such as a lid or door, that is movable between an open position and a closed position. The open position may enable insertion of an aerosol-generating article into the article cavity, and the closed position may substantially prevent or inhibit removal of an aerosol-generating article from the article cavity. The movable closure may be movably coupled, such as rotatably coupled or slidably coupled, to an external wall of the heating unit. The movable closure may be removably couplable to an external wall of the heating unit.

The aerosol-generating device may further comprise a resonating cavity between the article cavity and the electromagnetic field generator. As used herein the term “resonating cavity” refers to a structure that can confine electromagnetic waves of a given frequency. In this case, the frequency of choice of the electromagnetic waves corresponds to the RF region of the spectrum. In order to contain the electromagnetic waves, the resonant cavity is made of a reflective material for that frequency, for example, metals. The structure can be either hollow or filled with a dielectric material. The purpose of a resonant cavity is to allow the electromagnetic waves to bounce back and forth inside in order to reinforce the formation of standing waves and minimize power losses.

The resonating cavity amplifies the RF electromagnetic field at a resonant frequency and can be designed to match the impedance of the electromagnetic field generator and the load, in this case the aerosol-forming substrate in the article cavity, so as to optimise absorption of energy by the load and minimise reflection of the radiation from the load. This improves heating efficiency and minimises radiation leakage from the system. The resonating cavity may be positioned between the electromagnetic field generator and the article cavity.

The shisha device may comprise a wave guide. The wave guide may be adjacent to the article cavity. The wave guide may be provided to allow the RF electromagnetic field to enter the article cavity through one or more slots or entry points. RF radiation may propagate freely within the wave guide. The wave guide may have external walls that are not transparent to RF electromagnetic radiation. The wave guide may be arranged between the electromagnetic field generator and the article cavity. The wave guide may be arranged between the electromagnetic field generator and a resonating cavity.

The aerosol-generating device may further comprise an antenna connected to the electromagnetic field generator and configured to direct the RF electromagnetic field. The aerosol-generating device may further comprise a plurality of antennas connected to the electromagnetic field generator and configured to direct the RF electromagnetic field. The one or more antennas may be positioned at least partially in the article cavity. In use, the one or more antennas may be positioned at least partially with an aerosol-forming substrate in the article cavity. In use, the one or more antennas may be configured to puncture a container or wrapper encasing the aerosol-forming substrate. The one or more antennas may pass through a slot in an external wall of the article cavity. The one or more antennas may be coupled to a wave guide. The one or more antennas may be coupled to a wave guide that is coupled to the electromagnetic field generator. The one or more antennas may be arranged at least partially in a resonating cavity. The one or more antennas may be arranged between the electromagnetic field generator and the article cavity. The one or more antennas may be arranged between a wave guide and the article cavity. The one or more antennas may be arranged between a wave guide and a resonating cavity.

The provision of an antenna to direct the radiation generated by the electromagnetic field generator may improve the efficiency of the device. The one or more antennas may comprise an electrically conductive pin.

The shisha device may comprise an air inlet. The air inlet may enable ambient air to be drawn into the shisha device. A device housing of the shisha device may comprise the air inlet. The air inlet may enable ambient air to be drawn into the article cavity. In embodiments in which one or more ends of the article cavity are at an external surface of the shisha device, the article cavity may comprise the air inlet. In embodiments in which the article cavity comprises an open end for receiving an aerosol-generating article, the open end may form the air inlet.

An air flow path may be defined between the air inlet and the headspace outlet. The air flow path may extend through the article cavity. The air flow path may extend from the article cavity into the liquid cavity. The air flow path may extend from the article cavity, via an airflow conduit, and into the liquid cavity, below a liquid fill level of the liquid cavity. The airflow path may extend from below the liquid fill level of the liquid cavity to the headspace of the liquid cavity, and out of the headspace outlet.

The air flow path may comprise one or more labyrinthine portions extending past one or more radiation shielding elements. In embodiments in which the air flow path passes through the article cavity or through the generated RF electromagnetic field, the air flow path may comprise a labyrinthine portion past one or more radiation shielding elements to prevent the escape of RF radiation through the air inlet or the air outlet. One of more fluid permeable radiation shielding elements may be provided in the air flow path. For example, a metal mesh may be provided in the air flow path.

In some embodiments, the article cavity is configured such that an air flow path through the article cavity is aligned with the airflow conduit. In some embodiments, the article cavity is configured such that an air flow path through the article cavity is substantially aligned with the direction at which the RF electromagnetic field enters the cavity. In some embodiments, the article cavity is configured such that an air flow path through the article cavity is substantially transverse to the direction at which the RF electromagnetic field enters the cavity.

In some embodiments, the article cavity comprises a first end, a second end opposite the first end, and a side extending between the first end and the second end. In these embodiments, the article cavity may be configured for air to flow through the article cavity between the first end and the second end. In these embodiments, the article cavity may be configured to enable the RF electromagnetic energy to enter the article cavity at the side. For example, one or more slots may be provided in a side wall of the article cavity formed from a material opaque to the RF electromagnetic field. For example a side wall of the cavity may comprise a material that is substantially transparent to the RF electromagnetic field.

In some embodiments, the article cavity comprises a first end, a second end opposite the first end, a first side extending between the first end and the second end, and a second side, opposite the first side, extending between the first end and the second end. The article cavity may be configured for air to flow through the article cavity between the first side and the second side. The article cavity may be configured to enable the RF electromagnetic energy to enter the article cavity at least at one of the first end and the second end.

With the use of a RF transistor to generate the RF electromagnetic field, it is possible to use a closed loop control scheme. The shisha device may comprise a sensor in or adjacent to the article cavity, the sensor providing a signal indicative of a temperature in the article cavity, and a controller connected to receive the signal from the sensor and connected to control the electromagnetic field generator in dependence on the signal from the sensor.

The sensor may comprise a temperature sensor that directly measures temperature. The sensor may comprise a sampling antenna or a plurality of sampling antennas configured to detect perturbation of the electromagnetic field in the article cavity, which is indicative of the temperature in the article cavity. The dielectric properties of the aerosol-forming substrate change in dependence on temperature. The frequency or amplitude, or both frequency and amplitude, of the electromagnetic field may be adjusted by the controller based on the signal from the sensor to control the heating provided by the device.

Overheating may be detected by the sensor, and underheating may be detected by the sensor. The frequency and amplitude of the electromagnetic field may be adjusted accordingly depending on whether overheating or underheating are detected. Control circuitry of the shisha device may be configured to adjust at least one of the frequency and amplitude of the electromagnetic field based on whether overheating is detected by the sensor or overheating is detected by the sensor.

Malfunctions may be detected by the sensor. If a malfunction is detected, the shisha device may automatically switch off. It may also be possible to detect the presence of inappropriate materials in the article cavity. If an inappropriate material is detected in the article cavity, the shisha device may automatically switch off. Similarly, if the signal for the sensor suggests that no aerosol-forming substrate is present in the article cavity, the device may automatically switch off. To automatically switch off the shisha device, control circuitry of the shisha device may be configured to prevent power from being supplied to the electromagnetic field generator. This kind of control is not possible if a magnetron is used to generate RF radiation.

It may be desirable to maintain the temperature within the article cavity within a predetermined temperature range. It may be desirable to maintain the temperature of the aerosol-forming substrate below a temperature at which the aerosol-forming substrate combusts.

The ability to control the amount of heating provided by the shisha device based on a feedback signal also allows different aerosol-forming substrates to be used. Different aerosol-forming substrates may desirably be heated to different temperatures. Accordingly, providing a mechanism for temperature control allows optimal conditions to be achieved for different aerosol-forming substrates or different designs of aerosol-forming article.

The shisha device may comprise a puff detector configured to detect when a user takes a puff on the shisha device. As used herein, the term “puff” is used to refer to a user drawing on the shisha device to receive aerosol. The puff detector may comprise a temperature sensor. The puff detector may comprise a pressure sensor. The puff detector may comprise both a temperature sensor and a pressure sensor.

The shisha device may comprise control circuitry. The control circuitry may be configured to control the supply of power to the electromagnetic field generator. The control circuitry may comprise one or more of: a microprocessor, a programmable microprocessor, a microcontroller, and an application specific integrated chip (ASIC) or other electronic circuitry capable of providing control. The control circuitry may comprise further electronic components. For example, in some embodiments, the control circuitry may comprise one or more of: sensors, switches and display elements. The control circuitry may comprise a RF power sensor. The control circuitry may comprise a power amplifier.

In some embodiments, the shisha device is configured to be connected to an external power source. For example, the shisha device may be configured to be connected to a mains power source.

In some embodiments, the shisha device comprises a power source. The power source may be a DC power source. The power source may comprise a battery or another form of charge storage device, such as a capacitor. The power source may comprise a rechargeable lithium ion battery. In some embodiments, the power source is a rechargeable power source. The shisha device may be configured to be connected to an external power source for recharging the rechargeable power source.

The control circuitry may be configured to control the power supplied to the electromagnetic field generator from the power source.

The power source may provide a power of between about 0.5 Watts and about 50 Watts. In some embodiments, the power source may provide a power of between about 1 Watt and about 40 Watts, or between about 2 Watts and about 30 Watts.

Where the electromagnetic field generator is a solid state RF transistor, the impedance of the electromagnetic field generator may be less than or equal to about 100 Ohms. The impedance of the electromagnetic field generator may be less than or equal to 75 Ohms. The impedance of the electromagnetic field generator may be greater than about 1 Ohm. The impedance of the electromagnetic field generator may be greater than about 10 Ohms. The impedance of the electromagnetic field generator may be between 50 and 75 Ohms.

Where the electromagnetic field generator is a solid state RF transistor, the forward voltage across the electromagnetic field generator may be less than or equal to about 100 Volts. The forward voltage across the electromagnetic field generator may be greater than or equal to about 1 Volt. the forward voltage across the electromagnetic field generator may be between about 1 Volt and about 100 Volts.

The shisha device may include a vessel. The liquid cavity may be an interior volume of a vessel. The vessel may be configured to contain a liquid. The vessel may define the liquid cavity. The vessel may comprise the headspace outlet. The vessel may define a liquid fill level. For example, the vessel may comprise a liquid fill level demarcation. A liquid fill level demarcation is an indicator provided on the vessel to indicate the desired level to which the liquid cavity is intended to be filled with liquid. The headspace outlet may be arranged above the liquid fill level. The headspace outlet may be arranged above the liquid fill level demarcation. The vessel may comprise an optically transparent portion. The optically transparent portion may enable a user to observe the contents contained in the vessel. The vessel may be formed from any suitable material. For example, the vessel may be formed from glass or a rigid plastic material. In some embodiments, the vessel is removable from the rest of the shisha assembly. In some embodiments, the vessel is removable from an aerosol-generating portion of the shisha assembly. Advantageously, a removable vessel enables a user to fill the liquid cavity with liquid, empty the liquid cavity of liquid, and clean the vessel.

The vessel may be filled to a liquid fill level by a user. The liquid preferably comprises water. The liquid may comprise water infused with one or more of colorants and flavourants. For example, the water may be infused with one or both of botanical and herbal infusions.

The vessel may have any suitable shape and size. The liquid cavity may have any suitable shape and size. The headspace may have any suitable shape and size.

Typically, a shisha device according to this disclosure is intended to be placed on a surface in use, rather than being carried by a user. As such, a shisha device according to this disclosure may have a particular use orientation, or range of orientations, at which the device is intended to be oriented during use. Accordingly, as used herein, the terms ‘above’ and ‘below’ refer to relative positions of features of a shisha device or a shisha system when the shisha device or shisha system is held in a use orientation.

In some embodiments, the article cavity is arranged above the liquid cavity. In these embodiments, an airflow conduit may extend from the article cavity to below a liquid fill level of the liquid cavity. Advantageously, this may ensure that volatile compounds released from aerosol-forming substrate in the article cavity are delivered from the article cavity to the volume of liquid in the liquid cavity, rather than to the headspace above the liquid cavity. In these embodiments, the airflow conduit may extend from the aerosol cavity into the liquid cavity through the headspace in the liquid cavity above the liquid fill level, and into the volume of liquid below the liquid fill level. The airflow conduit may extend into the liquid cavity through a top or upper end of the liquid cavity.

In some embodiments, the article cavity is arranged below the liquid cavity. In these embodiments, a one-way valve may be arranged between the article cavity and the liquid cavity. The one-way valve may prevent liquid from the liquid cavity from entering the article cavity under the influence of gravity. In these embodiments, the one-way valve may be provided in an airflow conduit extending from the article cavity into the liquid cavity. In these embodiments, the airflow conduit may extend into the liquid cavity to below the liquid fill level. The airflow conduit may extend into the liquid cavity through a bottom end of the liquid cavity.

According to some particularly preferred embodiments of this disclosure, there is provided a shisha device for heating an aerosol-forming substrate to generate an aerosol, the shisha device comprising: a liquid cavity configured to contain a volume of liquid, the liquid cavity having a head space outlet; an article cavity configured to receive an aerosol-forming substrate, the article cavity being in fluid communication with the liquid cavity; and an electromagnetic field generator configured to generate a radio frequency (RF) electromagnetic field in the article cavity, the electromagnetic field generator comprising a solid state RF transistor.

According to some particularly preferred embodiments of this disclosure, there is provided a shisha device for heating an aerosol-forming substrate to generate an aerosol, the shisha device comprising: a liquid cavity configured to contain a volume of liquid, the liquid cavity having a head space outlet; an article cavity configured to receive an aerosol-forming substrate; an airflow conduit extending between the article cavity and the liquid cavity, the airflow conduit fluidly connecting the article cavity and the liquid cavity; a mouthpiece fluidly connected to the headspace outlet of the liquid cavity; and an electromagnetic field generator configured to generate a radio frequency (RF) electromagnetic field in the article cavity.

According to some particularly preferred embodiments of this disclosure, there is provided a shisha device for heating an aerosol-forming substrate to generate an aerosol, the shisha device comprising: a liquid cavity configured to contain a volume of liquid, the liquid cavity having a head space outlet; a heating unit comprising an article cavity configured to receive an aerosol-forming substrate, and an external housing formed from a material opaque to a RF electromagnetic field; an airflow conduit extending between the article cavity and the liquid cavity, the airflow conduit fluidly connecting the article cavity and the liquid cavity; a mouthpiece fluidly connected to the headspace outlet of the liquid cavity; and an electromagnetic field generator configured to generate a radio frequency (RF) electromagnetic field in the article cavity.

In this disclosure there is also provided an aerosol-generating article for use with a shisha device as previously described.

The aerosol-generating article may be any suitable type of aerosol-generating article for use with a shisha device. An aerosol-generating article specifically designed for use with a shisha device may be referred to as a cartridge for a shisha device. An aerosol-generating article specifically designed for use with a shisha device having an electromagnetic field generator may be referred to as a cartridge for a shisha device having an electromagnetic field generator.

The aerosol-generating article may have any suitable shape and size. In particular, the aerosol-generating article may have a shape and a size that is complementary to an article cavity of a shisha device.

The aerosol-generating article may have any suitable transverse cross-section. For example, the aerosol-generating article may have a circular, oval, rectangular, square, triangular or any other polygonal transverse cross-sectional shape.

In some embodiments, the aerosol-generating article is substantially cylindrical.

In some embodiments, the aerosol-generating article is substantially frustoconical. In some embodiments, the width or diameter of a first end of the aerosol-generating article is greater than the width or diameter of a second end of the aerosol-generating article, opposite the first end. In other words, the aerosol-generating article may be tapered from a first end to a second end. Providing the aerosol-generating article with a second end that is narrower than a first end may enable the aerosol-generating article to be retained in a complementary article cavity under the influence of gravity.

The aerosol-generating article may have a length of between about 10 millimetres and about 100 millimetres, between about 20 millimetres and about 90 millimetres or between about 25 millimetres and about 80 millimetres. In some preferred embodiments, the aerosol-generating article may have a length of about 33 millimetres, about 34 millimetres, about 35 millimetres, about 36 millimetres, about 37 millimetres, about 38 millimetres, 39 millimetres, about 40 millimetres, about 41 millimetres or about 42 millimetres. The aerosol-generating article may have a width or diameter of between about 5 millimetres and about 70 millimetres, or between about 10 millimetres and about 60 millimetres or between about 10 millimetres and about 50 millimetres. In some preferred embodiments, the aerosol-generating article may have a width or diameter of about 35 millimetres, about 36 millimetres, about 37 millimetres, about 38 millimetres, 39 millimetres, about 40 millimetres, about 41 millimetres, about 42 millimetres, about 43 millimetres, about 44 millimetres or about 45 millimetres.

The aerosol-generating article comprises aerosol-forming substrate. The aerosol-forming substrate may be encased in a wrapper or container. In some embodiments, the aerosol-forming substrate may be coated in a coating.

A wrapper may define a substrate cavity. The aerosol-forming substrate may be positioned in a substrate cavity within a wrapper.

In some embodiments, the wrapper may comprise a material opaque to a RF electromagnetic field. In some embodiments, at least a portion of the wrapper comprises a material opaque to a RF electromagnetic field. In some embodiments, the entire wrapper may comprise a material opaque to a RF electromagnetic field.

One or more slots may be formed in the wrapper to allow for ingress of the RF electromagnetic field to the aerosol-forming substrate. In particular, where an entire wrapper comprises a material opaque to a RF electromagnetic field, one or more slots may be formed in the wrapper to allow for ingress of the electromagnetic field to the aerosol-forming substrate.

At least a portion of the wrapper maybe fluid permeable. A fluid permeable portion of the wrapper may enable volatile compounds released from the aerosol-forming substrate to be released from the aerosol-generating article. A portion of the wrapper comprising material opaque to a RF electromagnetic field may also be fluid permeable. For example, a fluid permeable material that is opaque to a RF electromagnetic field may be a metal mesh. Accordingly, at least a portion of the wrapper may be formed from a metal mesh. In some embodiments, the wrapper may be formed from a metal mesh.

The aerosol-forming substrate may be encased in a container. A container may define a substrate cavity. The aerosol-forming substrate may be positioned in a substrate cavity within a container.

In some embodiments, the container may comprise a material opaque to a RF electromagnetic field.

In some embodiments, the container may comprise one or more walls. At least one wall of the container may comprise a material opaque to a RF electromagnetic field. All of the walls of the container may comprise a material opaque to a RF electromagnetic field.

The container may comprise a top wall, a bottom wall and a side wall extending between the top wall and the bottom wall. The top wall may be comprised of a material opaque to a RF electromagnetic field. The bottom wall may be comprised of a material opaque to a RF electromagnetic field. The side wall may be comprised of a material opaque to a RF electromagnetic field. In some embodiments, the top wall, bottom wall and side wall each comprise a material opaque to a RF electromagnetic field.

One or more slots may be formed in the container to allow for ingress of the RF electromagnetic field. In particular, where the top wall, bottom wall and side wall of the container each comprise a material opaque to a RF electromagnetic field, one or more slots may be formed in the container to allow for ingress of the RF electromagnetic field to the aerosol-forming substrate.

In some embodiments comprising a container, the top and bottom walls of the container comprise a material opaque to a RF electromagnetic field. In some of these embodiments, the side wall does not comprise material opaque to a RF electromagnetic field, to enable ingress of a RF electromagnetic field at the side wall.

In some embodiments comprising a container, the side wall of the container comprises a material opaque to the RF electromagnetic field. In some of these embodiments, the top wall comprises a material opaque to the RF electromagnetic field, and the bottom wall does not comprise material opaque to a RF electromagnetic field, to enable ingress of a RF electromagnetic field at the bottom wall. In some of these embodiments, the bottom wall comprises a material opaque to a RF electromagnetic field, and the top wall does not comprise material opaque to a RF electromagnetic field, to enable ingress of a RF electromagnetic field at the top wall.

In some embodiments comprising a container in which the top wall, bottom wall and side wall each comprise a material opaque to a RF electromagnetic field, one or more slots are formed in a wall of the container to allow for ingress of the electromagnetic field. In some of these embodiments, one or more slots are formed in the top wall. In some of these embodiments, one or more slots are formed in the bottom wall. In some of these embodiments, one or more slots are formed in the side wall.

At least a portion of the container maybe fluid permeable. A fluid permeable portion of the container may enable volatile compounds released from the aerosol-forming substrate to be released from the aerosol-generating article. A wall of the container comprising material opaque to a RF electromagnetic field may also be fluid permeable. For example, a fluid permeable material that is opaque to a RF electromagnetic field may be a metal mesh. Accordingly, at least a portion of the container may be formed from a metal mesh. In some embodiments, the container may be formed from a metal mesh.

In some embodiments, at least a portion of the aerosol-forming substrate is coated with a coating. As used herein, the term ‘coating’ refers to a layer of material that covers and is adhered to the aerosol-forming substrate. The coating may be applied to cover and adhere to at least a portion of the aerosol-forming substrate by any suitable methods known in the art, including, but not limited to, spray-coating, vapour deposition, dipping, material transfer (for example, brushing or gluing), electrostatic deposition or any combination thereof.

In some embodiments, the coating may comprise a material opaque to a RF electromagnetic field.

One or more regions of the external surface of the aerosol-forming substrate may be exposed. In other words, one or more regions of the external surface of the aerosol-forming substrate may be free from any coating. This may ensure that volatile compounds released from the aerosol-forming substrate are able to escape from the aerosol-generating article. Where the coating comprises a material opaque to a RF electromagnetic field, this may also enable ingress of a RF electromagnetic field to the aerosol-forming substrate.

In some embodiments, the coating may comprise a fluid permeable material.

In some embodiments, one or more regions of the external surface of the aerosol-forming substrate may be coated with a first coating, and one or more regions of the external surface of the aerosol-forming substrate may be coated with a second coating. One of the first coating and the second coating may comprise a material opaque to a RF electromagnetic field. One of the first coating and the second coating may comprise a fluid permeable material. In some preferred embodiments, one of the first coating and the second coating comprises a material opaque to a RF electromagnetic field, and the other of the first coating and the second coating comprises a fluid permeable material. This may enable ingress of a RF electromagnetic field into the aerosol-forming substrate at one region of the aerosol-forming substrate, and may enable air to be drawn though the aerosol-forming substrate at another region of the aerosol-forming substrate, without enabling egress of a RF electromagnetic field from the aerosol-forming substrate at that region.

In some embodiments, at least a portion of a wrapper or container encasing the aerosol-forming substrate is coated with a coating. The coating may comprise a material opaque to a RF electromagnetic field.

The aerosol-forming substrate may be any suitable substrate capable of releasing volatile compounds on heating.

In some preferred embodiments, the aerosol-forming substrate is in the form of a suspension. For example, the aerosol-forming substrate may include molasses. As used herein, “molasses” means an aerosol-forming substrate composition comprising a suspension having at least about 20 percent by weight of sugar. For example, the molasses may include at least about 25 percent by weight of sugar, such as at least about 35 percent by weight of sugar. Typically, the molasses will contain less than about 60 percent by weight of sugar, such as less than about 50 percent by weight of sugar.

Preferably, the aerosol-forming substrate is a shisha substrate. As used herein, a “shisha substrate” refers to an aerosol-forming substrate composition comprising at least about 20 percent by weight of sugar. A shisha substrate may comprise molasses. A shisha substrate may comprise a suspension having at least about 20 percent by weight of sugar.

The aerosol-forming substrate may be solid or liquid or comprise both solid and liquid components.

The aerosol-forming substrate may include nicotine. The nicotine containing aerosol-forming substrate may include a nicotine salt matrix. The aerosol-forming substrate may include plant-based material. The aerosol-forming substrate preferably includes tobacco. The tobacco containing material preferably contains volatile tobacco flavour compounds, which are released from the aerosol-forming substrate upon heating. The aerosol-forming substrate may include homogenized tobacco material. Homogenized tobacco material may be formed by agglomerating particulate tobacco. The aerosol-forming substrate may include a non-tobacco-containing material. The aerosol-forming substrate may include homogenized plant-based material.

The aerosol-forming substrate may include, for example, one or more of: powder, granules, pellets, shreds, spaghettis, strips, or sheets. The aerosol-forming substrate may contain one or more of: herb leaf, tobacco leaf, fragments of tobacco ribs, reconstituted tobacco, homogenized tobacco, extruded tobacco, and expanded tobacco. The tobacco may be flue cured.

The aerosol-forming substrate may include at least one aerosol former. Suitable aerosol formers include compounds or mixtures of compounds which, in use, facilitate formation of a dense and stable aerosol and which are substantially resistant to thermal degradation at the operating temperature of the shisha device. Suitable aerosol formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Particularly preferred aerosol formers are polyhydric alcohols or mixtures thereof, such as triethylene glycol, 1,3-butanediol and, most preferred, glycerine. The aerosol-former may be propylene glycol. The aerosol-forming substrate may include any suitable amount of an aerosol former. For example, the aerosol former content of the substrate may be equal to or greater than 5 percent on a dry weight basis, and preferably greater than 30 percent by weight on a dry weight basis. The aerosol former content may be less than about 95 percent on a dry weight basis. Preferably, the aerosol former content is up to about 55 percent on a dry weight basis

The aerosol-forming substrate preferably includes nicotine and at least one aerosol former. In some embodiments, the aerosol former is glycerine or a mixture of glycerine and one or more other suitable aerosol formers, such as those listed above. In some embodiments, the aerosol-forming is propylene glycol.

The aerosol-forming substrate may include other additives and ingredients, such as flavourants. In some examples, the aerosol-forming substrate includes one or more sugars in any suitable amount. Preferably, the aerosol-forming substrate includes invert sugar. Invert sugar is a mixture of glucose and fructose obtained by splitting sucrose. Preferably, the aerosol-forming substrate includes between about 1 percent and about 40 percent sugar, such as invert sugar, by weight. In some example, one or more sugars may be mixed with a suitable carrier such as cornstarch or maltodextrin.

In some examples, the aerosol-forming substrate includes one or more sensory-enhancing agents. Suitable sensory-enhancing agents include flavourants and sensation agents, such as cooling agents. Suitable flavourants include natural or synthetic menthol, peppermint, spearmint, coffee, tea, spices (such as cinnamon, clove, ginger, or combination thereof), cocoa, vanilla, fruit flavours, chocolate, eucalyptus, geranium, eugenol, agave, juniper, anethole, linalool, and any combination thereof.

Any suitable amount of aerosol-forming substrate, such as molasses or tobacco substrate, may be provided in the aerosol-generating article. In some preferred embodiments, about 3 grams to about 25 grams of the aerosol-forming substrate is provided in the aerosol-generating article. The cartridge may include at least 6 grams, at least 7 grams, at least 8 grams, or at least 9 grams of aerosol-forming substrate. The cartridge may include up to 15 grams, up to 12 grams; up to 11 grams, or up to 10 grams of aerosol-forming substrate. Preferably, from about 7 grams to about 13 grams of aerosol-forming substrate is provided in the aerosol-generating article.

The aerosol-forming substrate may be provided on or embedded in a thermally stable carrier. The term “thermally stable” is used herein to indicate a material that does not substantially degrade at temperatures to which the substrate is typically heated (e.g., about 150° C. to about 300° C.). The carrier may comprise a thin layer on which the substrate deposited on a first major surface, on second major outer surface, or on both the first and second major surfaces. The carrier may be formed of, for example, a paper, or paper-like material, a non-woven carbon fibre mat, a low mass open mesh metallic screen, or a perforated metallic foil or any other thermally stable polymer matrix. Alternatively, the carrier may take the form of powder, granules, pellets, shreds, spaghettis, strips or sheets. The carrier may be a non-woven fabric or fibre bundle into which tobacco components have been incorporated. The non-woven fabric or fibre bundle may comprise, for example, carbon fibres, natural cellulose fibres, or cellulose-derivative fibres.

In some preferred embodiments, the aerosol-forming substrate may comprise tobacco, sugar and an aerosol-former. In these embodiments, the aerosol-forming substrate may comprise between 10 percent and 40 percent by weight of tobacco. In these embodiments, the aerosol-forming substrate may comprise between 20 percent and 50 percent by weight of sugar. In these embodiments, the aerosol-forming substrate may comprise between 25 percent and 55 percent by weight of aerosol-former. In some particularly preferred embodiments, the aerosol-forming substrate comprises between 20 percent and 30 percent by weight of tobacco, between 30 percent and 40 percent by weight of sugar, and between 35 percent and 45 percent by weight of aerosol-former. In some particularly preferred embodiments, the aerosol-forming substrate may comprise about 25 percent by weight of tobacco, about 35 percent by weight of sugar and about 40 percent by weight of aerosol-former. In these preferred embodiments, the tobacco may be flue cured tobacco leaf. In these preferred embodiments, the sugar may be sucrose or invert sugar. In these preferred embodiments, the aerosol-former may be propylene glycol.

According to some particularly preferred embodiments of this disclosure, there is provided an aerosol-generating article for a shisha system, the aerosol-generating article comprising: an aerosol-forming substrate composition comprising a suspension having at least about 20 percent by weight of sugar; and one or more external surfaces formed from a material opaque to the RF electromagnetic field.

According to some particularly preferred embodiments of this disclosure, there is provided an aerosol-generating article for a shisha system, the aerosol-generating article comprising: an aerosol-forming substrate; and a coating applied to at least a portion of an external surface of the aerosol-forming substrate formed from a material opaque to the RF electromagnetic field.

According to some particularly preferred embodiments of this disclosure, there is provided an aerosol-generating article for a shisha system, the aerosol-generating article comprising: an aerosol-forming substrate; and a wrapper encasing the aerosol-forming substrate, the wrapper comprising one or more fluid permeable regions, and one or more regions formed from a material opaque to the RF electromagnetic field.

In this disclosure, there is provided a shisha system comprising a shisha device as previously described and an aerosol-generating article comprising an aerosol-forming substrate.

In particular, in this disclosure, there is provided a shisha system comprising a shisha device as previously described and an aerosol-generating article as previously described.

In particular, in this disclosure there is provided a shisha system comprising a shisha device and an aerosol-generating article. The shisha device comprises: a liquid cavity configured to contain a volume of liquid, the liquid cavity having a head space outlet; an article cavity configured to receive an aerosol-forming substrate, the article cavity being in fluid communication with the liquid cavity; and an electromagnetic field generator configured to generate a radio frequency (RF) electromagnetic field in the article cavity. The aerosol-generating article comprises an aerosol-forming substrate.

In some of these embodiments, the article cavity comprises one or more walls formed from a material opaque to the RF electromagnetic field, and an opening to enable insertion of the aerosol-generating article into the article cavity. In these embodiments, the aerosol-generating article may comprise an external surface that is formed from a material opaque to the RF electromagnetic field. The external surface of the aerosol-generating article may be configured such that when the aerosol-generating article is received in the article cavity, the one or more walls of the article cavity formed from a material opaque to the RF electromagnetic field align with the external surface of the aerosol-generating article formed from a material opaque to the RF electromagnetic field to form an enclosure around the aerosol-forming substrate that is bounded by surfaces that are formed from materials opaque to the RF electromagnetic field.

It should be appreciated that features described in relation to a shisha device or an aerosol-generating article may also be applicable to a shisha system according to the disclosure.

It should also be appreciated that particular combinations of the various features described above may be implemented, supplied, and used independently.

Embodiments of the present disclosure will now be described, by way of example only, with reference to the accompanying drawings, in which:

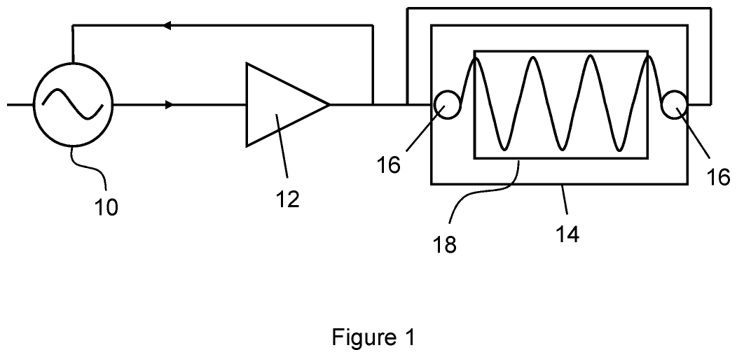

FIG. 1 is a schematic illustration of a dielectric heating system;

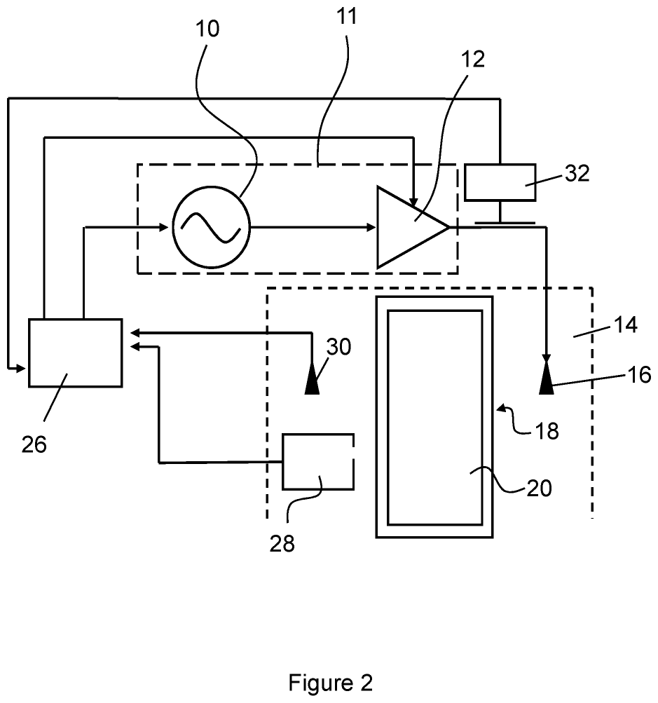

FIG. 2 is a schematic illustration of a closed-loop control system for a shisha system having a dielectric heating system according to embodiments of the disclosure;

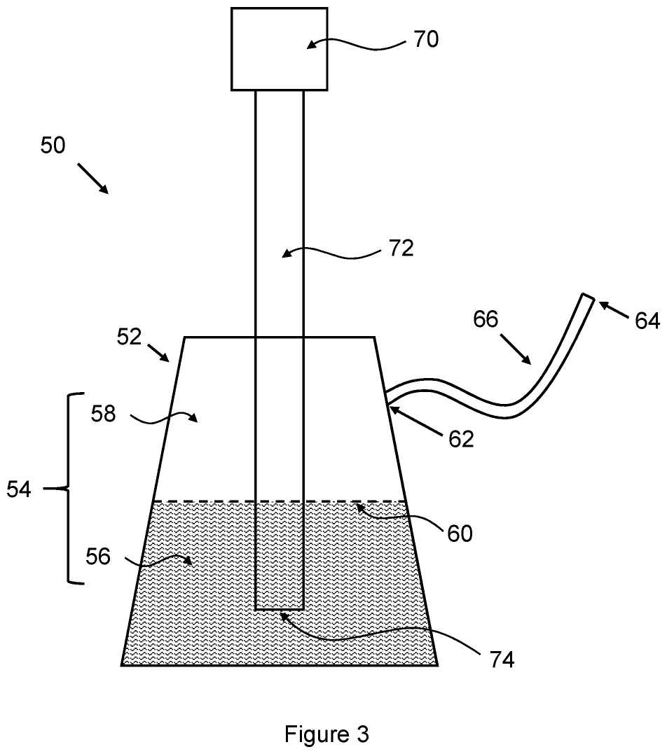

FIG. 3 is a schematic illustration of an embodiment of a shisha system having a dielectric heating system;

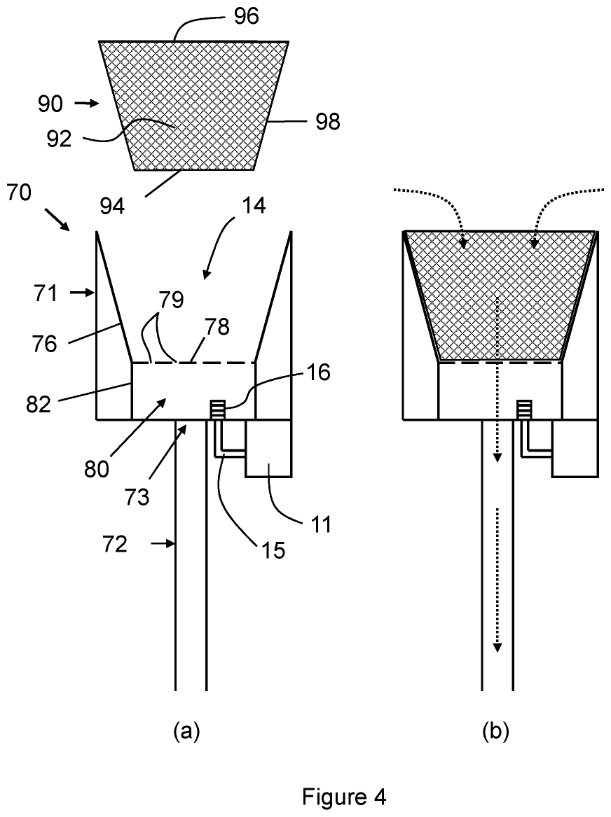

FIG. 4 is a schematic illustration of a heating unit of a shisha device and an aerosol-generating article configured for use with the shisha device according to an embodiment of the disclosure;

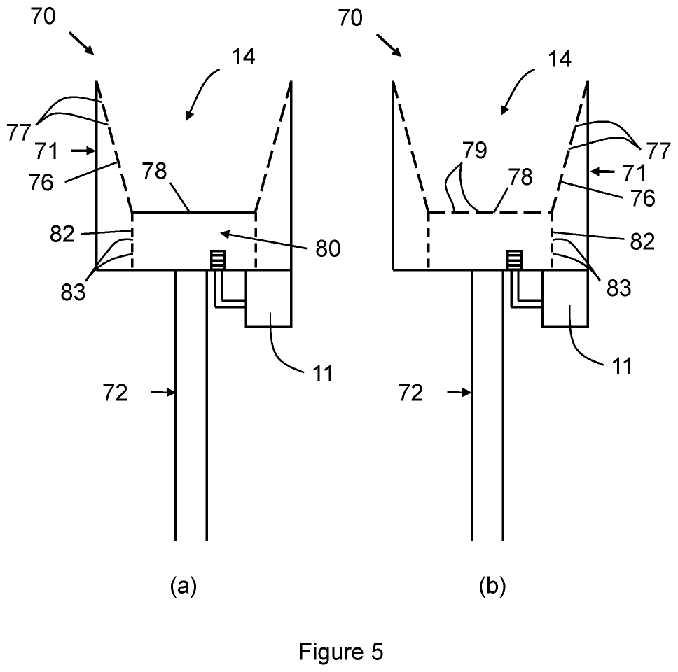

FIG. 5 is a schematic illustration of heating units of different embodiments of a shisha device according to embodiments of the disclosure;

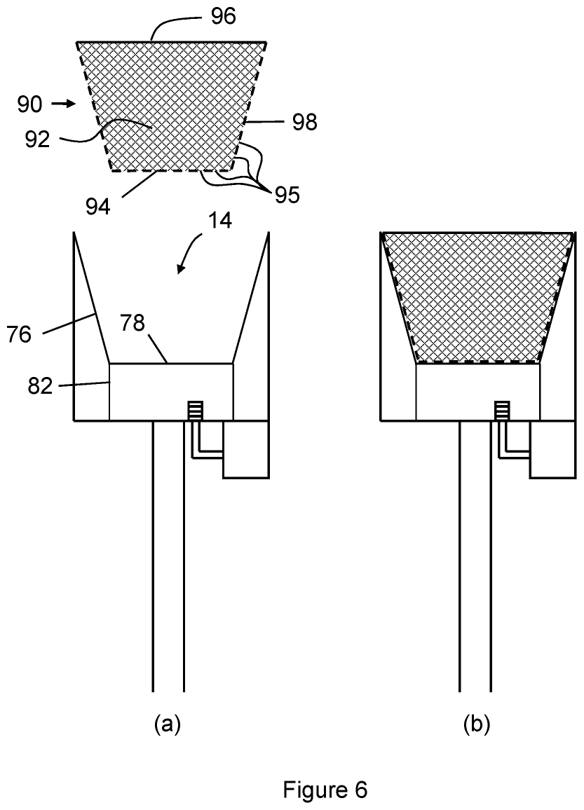

FIG. 6 is a schematic illustration of a heating unit of a shisha device and an aerosol-generating article configured for use with the shisha device according to an embodiment of the disclosure;

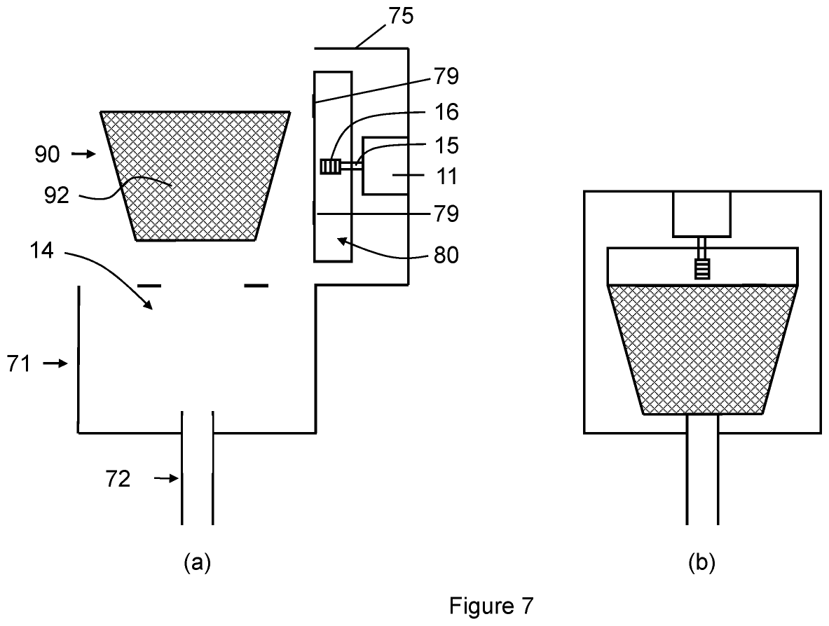

FIG. 7 is a schematic illustration of a heating unit of a shisha device and an aerosol-generating article configured for use with the shisha device according to an embodiment of the disclosure;

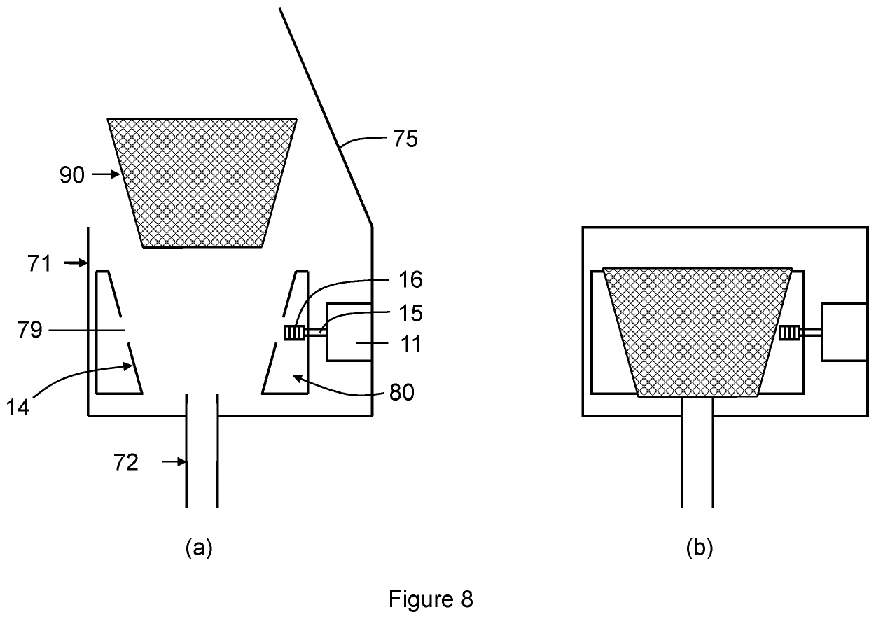

FIG. 8 is a schematic illustration of a heating unit of a shisha device and an aerosol-generating article configured for use with the shisha device according to an embodiment of the disclosure; and

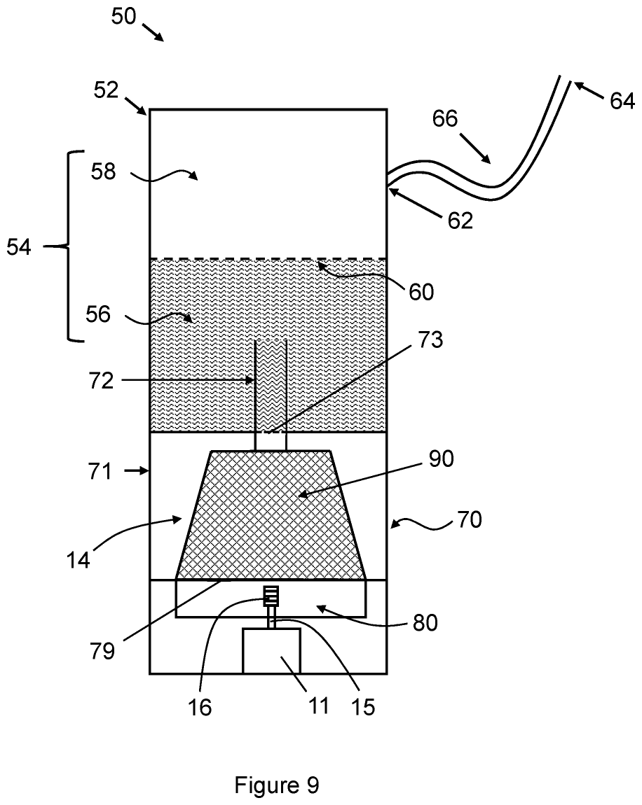

FIG. 9 is a schematic illustration of an embodiment of a shisha system having a dielectric heating system.

FIG. 1 is a schematic illustration of a system for heating using radio frequency (RF) electromagnetic radiation, sometimes referred to as dielectric heating. The system comprises a radio frequency signal generator 10, a power amplifier 12 connected to the signal generator to amplify the radio frequency signal, and antennas 16 positioned inside an article cavity 14, the antennas 16 being connected to an output of the power amplifier 12. The output of the power amplifier 12 is fed back to the signal generator 10 to provide closed-loop control. An article 18, which is to be heated, is placed in the article cavity 14 and subjected to radio frequency electromagnetic radiation. Polar molecules within the article 18 align with the oscillating electromagnetic field and so are agitated by the electromagnetic field as it oscillates. This causes an increase in temperature of the article 18. This kind of heating has the advantage that it is uniform throughout the article (provided that the polar molecules are uniformly distributed). It also has the advantage of being a non-contact form of heating, which does not require conduction or convection of heat from high temperature heating element.

FIG. 2 illustrates a control scheme that may be used in any of the embodiments described in FIGS. 3 to 9. As previously described, the system comprises control circuitry for the electromagnetic field generator. In the example of FIG. 2, the electromagnetic field generator 11 comprises a solid state RF LDMOS transistor that performs the function of both a RF signal generator 10 and a power amplifier 12 to amplify the generated RF electromagnetic signal. The output of the RF solid state transistor is passed to a radiating antenna 16 positioned to radiate an aerosol-forming substrate 20 positioned within an aerosol-generating article 18 that is received in an article cavity 14.

The control circuitry comprises a microcontroller 26 that can control both the frequency and the power output of the RF solid state transistor. One or more sensors provide input to the microcontroller 26. The microcontroller 26 adjusts the frequency or the power output, or both the frequency and the power output, of the electromagnetic field generator 11 based on the sensor inputs. In the example shown in FIG. 2, there is a temperature sensor 28 positioned to sense the temperature within the article cavity 14. A sampling antenna 30 may be provided in the article cavity 14 as an alternative, or in addition, to the temperature sensor 28. The sampling antenna 30 is configured as a receiver and can detect perturbation of the electromagnetic field in the article cavity 14, which is an indication of the efficiency of the energy absorption by the aerosol-forming substrate 20. A RF power sensor 32 is also provided to detect the power output from the electromagnetic field generator 11.

The microcontroller 26 receives signals from the RF power sensor 32, the temperature sensor 28 and the sampling antenna 30. The signals can be used to determine at least one of: whether the temperature is too low, whether the temperature is too high, if there is a fault, and if there is no substrate, or a substrate with inappropriate dielectric properties, in the article cavity 14.

Based on the determination made by the microcontroller 26, the frequency and power of the electromagnetic filed generated by the RF solid state transistor is adjusted or the electromagnetic filed is switched off. Typically, it is desirable to provide for a stable and consistent volume of aerosol, which means maintaining the aerosol-forming substrate within a particular temperature range. However, the desired target temperature may vary with time as the composition of the aerosol-forming substrate changes and the temperature of the surrounding system changes. Also, the dielectric properties of the aerosol-forming substrate change with temperature and so the electromagnetic field may need to be adjusted as temperature increases or decreases.

It should be clear that features described in relation one embodiment may be applied to other embodiments. The embodiments described provide the advantages of uniform, contactless heating of an aerosol-forming substrate in a manner that can be controlled to provide for particular, desirable aerosol properties. In comparison to conventional microwave heating using a magnetron, the use of a solid state RF transistor also allows for better control of frequency and power and longer operational lifetime.

The embodiments described with reference to FIGS. 3 to 8 use the basic heating and control principles illustrated in FIGS. 1 and 2. In addition, the embodiments described with reference to FIGS. 3 to 8 use a solid state radiofrequency (RF) transistor to perform both the signal generation and power amplification functions illustrated in FIG. 1. However, it would be possible to implement the embodiments described using a RF transistor for the signal generation and a separate electronic component or components to provide for the power amplification. It would also be possible to implement the embodiments described using conventional microwave heating systems, such as systems using a magnetron.

FIG. 3 is a schematic illustration of a shisha system according to an embodiment of this disclosure.

The shisha device 50 comprises a vessel 52 defining a liquid cavity 54. The vessel 52 is configured to retain a volume of liquid in the liquid cavity 54, and is formed from a rigid, optically transparent material, such as glass. In this embodiment, the vessel 52 has a substantially frustoconical shape, and is supported in use at its wide end on a flat, horizontal surface, such as a table or shelf. The liquid cavity 54 is divided into two sections, a liquid section 56 for receiving a volume of liquid, and a headspace 58 above the liquid section 58. A liquid fill level 60 is positioned at the boundary between the liquid section 56 and the headspace 58, the liquid fill level 60 being demarcated on the vessel 52 by a dashed line marked on an outer surface of the vessel 52. A headspace outlet 62 is provided on a side wall of the vessel 52, above the liquid fill level 60. The headspace outlet 62 enables fluid to be drawn out of the liquid cavity 54 from the headspace 58. A mouthpiece 64 is connected to the headspace outlet 62 by a flexible hose 66. A user may draw on the mouthpiece 64 to draw fluid out of the headspace 58 for inhalation.

The shisha device 50 further comprises a heating unit 70 comprising an electromagnetic field generator in accordance with the present disclosure. Examples of different heating units will be discussed in more detail below with reference to FIGS. 4, 5, 6, 7 and 8. The heating unit 70 is arranged above the vessel 52 by an airflow conduit 72. In this embodiment, the heating unit 70 is supported above the vessel 52 by the airflow conduit 72, however, it will be appreciated that in other embodiments the heating unit 70 may be supported above the vessel 52 by a housing of the shisha device or another suitable support. The airflow conduit 72 extends from the heating unit 70 into the liquid cavity 54 of the vessel 52. The airflow conduit 72 extends through the headspace 58, and below the liquid fill level 60 into the liquid section 58. The airflow conduit 72 comprises an outlet 74 in the liquid section 56 of the liquid cavity 54, below the liquid fill level 60. This arrangement enables air to be drawn from the heating unit 70 to the mouthpiece 64. Air may be drawn from an environment external to the device 50, into the heating unit 70, through the heating unit 70, though the airflow conduit 72 into the volume of liquid in the liquid section 56 of the liquid cavity 54, out of the volume of liquid into the headspace 58, and out of the vessel from the headspace 58 at the headspace outlet 62, through the hose 66 and to the mouthpiece 64.

In use, a user may draw on the mouthpiece 64 of the shisha device 50 to receive aerosol from the shisha device 50. In more detail, an aerosol-generating article comprising an aerosol-forming substrate can be positioned in an article cavity within the heating unit 70 of the shisha device 50. The heating unit 70 may be operated to heat the aerosol-forming substrate within the aerosol-generating article and release volatile compounds from the heated aerosol-forming substrate. When a user draws on the mouthpiece 64 of the shisha device 50, the pressure within the shisha device 50 is lowered, which draws the released volatile compounds from the aerosol-forming substrate out of the heating unit 70 and into the airflow conduit 72. The volatile compounds are drawn out of the airflow conduit 72 at the outlet 74, into the volume of liquid in the liquid section 56 of the liquid cavity 54. The volatile compounds cool in the volume of liquid and are released into the headspace 58 above the liquid fill level 60. The volatile compounds in the headspace 58 condense to form an aerosol that is drawn out of the headspace at the headspace outlet 62 and to the mouthpiece 64 for inhalation by the user.

FIG. 4 shows schematic illustrations of a heating unit 70 of the shisha device 50 of FIG. 3 in combination with an aerosol-generating article 90, forming a shisha system according to an embodiment of this disclosure. FIG. 4a shows the heating unit 70 and the aerosol-generating article 90 before insertion of the aerosol-generating article 90 into an article cavity 14 of the heating unit 70. FIG. 4b shows the aerosol-generating article 90 received in the article cavity 14 of the heating unit 70.

As shown in FIG. 4a, the heating unit 70 comprises an external housing 71. The external housing 71 forms a cylindrical tube that is open at one end for insertion of the aerosol-generating article 90, and is substantially closed at the opposite end. The external housing 71 is formed from a material that is opaque to RF electromagnetic radiation, such as aluminium.

An article cavity 14 is defined within the external housing 71 by a base 78 and a side wall 76, extending between the periphery of the base 78 and the open end of the external housing 71. The article cavity 14 is configured to receive the aerosol-generating article 90, and has a shape and size that is complementary to the aerosol-generating article 90. The diameter of the base 78 of the article cavity 14 is less than the diameter of the open end of the external housing 71, such that the side wall 76 is inclined relative to the cylindrical side wall of the external housing 71. Accordingly, the article cavity 14 has a substantially frustoconical shape that is open at its wide end to receive the aerosol-generating article 90. The side wall 76 and base 78 of the article cavity 14 are formed from a material that is opaque to RF electromagnetic radiation, such as aluminium. However, the base 78 of the article cavity 14 comprises a plurality of slots 79 configured to enable a RF electromagnetic field to propagate into the article cavity 14 via the base 78.

A resonating cavity 80 is located below the base 78 of the article cavity 14. In this embodiment, the resonating cavity 80 is defined between the base 78 of the article cavity 14, the substantially closed end of the external housing 71, and an interior wall 82. The interior wall 82 extends between the periphery of the base 78 of the article cavity 14 and the substantially closed end of the external housing 71. In this embodiment, the interior wall 82 is formed of a material opaque to RF electromagnetic radiation, such as aluminium.

It will be appreciated that in other embodiments, the position of the interior wall 82 may be altered in order to change the size and shape of the resonating cavity 80. It may be necessary to alter the position of the interior wall 82 to enable an electromagnetic field of a particular frequency to resonate within the resonating cavity 80.

Preferably, the base 78 and side wall 76 of the article cavity 14, and the interior wall 82 and external housing 71 have polished surfaces to improve reflection of RF radiation.

The heating unit 70 further comprises an electromagnetic field generator 11. The electromagnetic field generator 11 comprises a solid state RF LDMOS transistor that performs the function of both a RF signal generator and a power amplifier to amplify the generated RF electromagnetic signal. The output of the RF solid state transistor is coupled to a wave guide 15. The wave guide 15 extends into the resonating cavity 80 through the substantially closed end of the external housing 71. The wave guide 15 is coupled to an antenna 16, which is positioned within the resonating cavity 80 and configured to radiate the RF electromagnetic field generated by the RF solid state transistor into the resonating cavity 80.

The electromagnetic field generator 11 is connected to a power supply (not shown) and control circuitry (not shown) of the shisha device, the control circuitry being configured to control the supply of power from the power supply to the electromagnetic field generator 11. In this embodiment, the power supply is a rechargeable lithium ion battery, and the shisha device 50 comprises a power connector that enables the shisha device 50 to be connected to a mains power supply for recharging the power supply. Providing the shisha device 50 with a power supply, such as a battery, enables the shisha device 50 to be portable and used outdoors or in locations in which a mains power supply is not available.

The heating unit 70 is arranged above the vessel 52 of the shisha device 50 by the airflow conduit 72. The airflow conduit 72 is fixedly attached to the substantially closed end of the external housing 71 of the heating unit 70. It will be appreciated that in other embodiments, the heating unit 70 may be removably attached to the airflow conduit 72, such that the heating unit 70 may be removed for cleaning or replacement if necessary. An opening 73 is provided in the substantially closed end of the external housing 71 to fluidly connect the resonating cavity 80 to the airflow conduit 72. A radiation shielding element (not shown), in the form of a metal mesh, is provided over the opening 73 of the external housing 71 to substantially prevent egress of a RF electromagnetic field from within the resonating cavity 80 into the airflow conduit 72, without substantially affecting fluid flow between the resonating cavity 80 and the airflow conduit 72.

Accordingly, the heating unit 70 is configured such that air may be drawn from the article cavity 14 into the resonating cavity 80, through the slots 79 in the base 78, and from the resonating cavity 80 into the airflow conduit 72, through the opening 73 and the radiation shielding element.

The aerosol-generating article 90 comprises an aerosol-forming substrate 92. In this embodiment, the aerosol-forming substrate 92 is a shisha substrate, comprising molasses and tobacco. The aerosol-forming substrate 92 is encased within a container. The container has a substantially frustoconical shape, complementary to that of the article cavity 14. The container comprises a bottom wall 94, a top wall 96 and a side wall 98 extending between the bottom wall 94 and the top wall 96. The bottom wall 94 and side wall 98 of the container are formed from a material that is fluid permeable, and substantially transparent to a RF electromagnetic field, such as a perforated cardboard or plastic material. This enables air to be drawn into or out of the aerosol-generating article though the bottom wall 94 and the side wall 98 and enables ingress of a RF electromagnetic field into the aerosol-generating article through the bottom wall 94 and side wall 98. The top wall 96 comprises a material that is opaque to a RF electromagnetic field, such as a metal mesh. This enables air to be drawn into the aerosol-generating article through the top wall 96, and prevents egress of a RF electromagnetic field from the aerosol-generating article through the top wall 96.

As shown in FIG. 4b, when the aerosol-generating article 90 is received in the article cavity 14 of the heating unit 70, the bottom wall 94 of the aerosol-generating article 90 contacts the bottom wall 78 of the article cavity 14, and the side wall 98 of the aerosol-generating article 90 contacts the side wall 76 of the article cavity 14. The top wall 96, formed from a material opaque to the RF electromagnetic field, aligns with and contacts side wall 76 of the article cavity 14, which is also formed from a material opaque to the RF electromagnetic field. In this position, the aerosol-forming substrate 92 is surrounded by material opaque to the RF electromagnetic field, at the top wall 96 of the aerosol-generating article 90, and the side wall 76 and base 78 of the article cavity 14. The slots 79 in the base 78 of the article cavity 14 are the only entry and exit point for the RF electromagnetic field into and out of the aerosol-forming substrate 92.

When a user draws on the mouthpiece 64 of the shisha device 50, air is drawn into the shisha device 50 through the top wall 96 of the aerosol-generating article 90. An air flow path through the aerosol-generating article 90 and heating unit 70 is shown by the arrows in FIG. 4b. Air is drawn into the aerosol-generating article 90 through the top wall 96 of the aerosol-generating article 90, through the aerosol-forming substrate 92 and into the resonating cavity 80 of the heating unit 70 through the bottom wall 94 of the aerosol-generating article 90 and the slots 79 in the bottom wall 78 of the article cavity 14. From the resonating cavity 80, air is drawn into the airflow conduit 72 through the opening 73 in the external housing 71 of the heating unit 70.

In use, power is supplied to the electromagnetic field generator 11 from the power supply when a user activates the shisha device 50. In this embodiment, the shisha device is activated by a user pressing an activation button (not shown) provided on an external surface of the heating unit 70. It will be appreciated that in other embodiments, the shisha device may be activated in another manner, such as on detection of a user drawing on the mouthpiece 64 by a puff sensor provided on the mouthpiece 64. When power is supplied to the electromagnetic field generator 11, the electromagnetic field generator 11 generates and amplifies a RF electromagnetic field with a frequency of between 900 MHz and 2.4 GHz. The RF electromagnetic field is directed along the wave guide 15 and into the resonating cavity 80 by the antenna 16. From the resonating cavity 80, the RF electromagnetic field propagates into the aerosol-forming substrate 92 of the aerosol-generating article 90 via the slots 79 in the bottom wall 78 of the article cavity 14 and the bottom wall 94 of the aerosol-generating article 90. The top wall 96 of the aerosol-generating article 90 prevents egress of the RF electromagnetic field from the aerosol-generating article 90. The RF electromagnetic field dielectrically heats the aerosol-forming substrate 90, which releases volatile compounds. As described above, the temperature in the article cavity 14 can be regulated using a feedback control mechanism. The temperature inside the article cavity 14 can be sensed, or another parameter indicative of the temperature inside the substrate cavity can be sensed, to provide a feedback signal to the control circuitry of the shisha device 50. The control circuitry is configured to adjust the frequency or amplitude, or both the frequency and the amplitude, of the RF electromagnetic field in order to maintain the temperature inside the article cavity 14 within a desired temperature range.

When a user draws on the mouthpiece 64 of the shisha device 50, the volatile compounds released from the heated aerosol-forming substrate 90 are entrained in the air flow through the aerosol-generating article 90 and are drawn out of the aerosol-generating article 90, through the resonating cavity 80 and into the airflow conduit 72. From the airflow conduit, the volatile compounds are drawn through the shisha device 50 to and out of the mouthpiece 66 as described above.

FIG. 5 shows heating units 70 for a shisha device according to other embodiments of this disclosure. The heating units 70 shown in FIG. 5 are substantially similar to the heating unit 70 shown in FIG. 4, and like reference numerals are used to represent like features.

The heating unit 70 shown in FIG. 5a differs from the heating unit 70 shown in FIG. 4 in that the base 78 of the article cavity 14 does not comprise slots 79, and so the RF electromagnetic radiation is unable to propagate from the resonating cavity 80 into the article cavity 14 through the base 78 of the article cavity 14. In the embodiment of FIG. 5a, slots 83 are provided in the interior wall 82, and slots 77 are provided in the side wall 76 of the article cavity 14. Accordingly, the RF electromagnetic field is able to enter the article cavity 14 through the side wall 76 of the article cavity 14, via the slots 83 in the interior wall 82. This arrangement changes the size and shape of the resonating cavity 80 compared to the resonating cavity 80 of the embodiment of FIG. 4. Changing the size and shape of the resonating cavity 80 may be necessary when using a RF electromagnetic field of different frequencies, in order to ensure that the RF electromagnetic field resonates within the resonating cavity 80.

The heating unit 70 shown in FIG. 5b differs from the heating unit 70 shown in FIG. 4 in that, in addition to the base 78 of the article cavity 14 comprising slots 79, the interior wall 82 also comprises slots 83 and the side wall 76 of the article cavity 14 comprises slots 77, such that the RF electromagnetic field may enter the article cavity 14 through both the base 78 and the side wall 76 of the article cavity 14. This arrangement provides a further alternative size and shape for the resonating cavity 80, which may provide a suitable resonating cavity for a RF electromagnetic field of an alternative frequency.

FIG. 6 shows a heating unit 70 for a shisha device and an aerosol-generating article 90, forming a shisha system according to another embodiment of this disclosure. The heating unit 70 and aerosol-generating article 90 shown in FIG. 6 are substantially similar to the heating unit 70 and aerosol-generating article 90 shown in FIG. 4, and like reference numerals are used to represent like features. FIG. 6a shows the heating unit 70 and the aerosol-generating article 90 before insertion of the aerosol-generating article 90 into an article cavity 14 of the heating unit 70. FIG. 6b shows the aerosol-generating article 90 received in the article cavity 14 of the heating unit 70.

The heating unit 70 shown in FIG. 6 differs from the heating unit 70 shown in FIG. 4 in that the base 78 of the article cavity 14, the side wall 76 of the article cavity 14 and the interior wall 82 are all formed from a material that is substantially transparent to the RF electromagnetic field, such as a rigid plastic material, ceramic or clay. In this embodiment, each of the base 78 of the article cavity 14, the side wall 76 of the article cavity 14 and the interior wall 82 are each configured to be fluid permeable, such that air may be drawn through each of these walls. It will be appreciated that in other embodiments, the base 78 of the article cavity 14 may be fluid permeable and the side wall 76 of the article cavity 14 and the interior wall 82 may be substantially impermeable to fluid, or the side wall 76 of the article cavity 14 and the interior wall 82 may be fluid permeable and the base 78 of the cavity 14 may be substantially fluid impermeable.

The aerosol-generating article 90 shown in FIG. 6 differs from the aerosol-generating article 90 shown in FIG. 4 in that the bottom wall 94 and the side wall 80 of the aerosol-generating article are formed from a material that is opaque to the RF electromagnetic field. To allow the RF electromagnetic field to enter the aerosol-generating article 90, and heat the aerosol-forming substrate 92, a plurality of slots 95 are provided in the bottom wall 94 and the side wall 90. It will be appreciated that in some embodiments, only one slot will be provided, on one of the bottom wall and the top wall. It will also be appreciated that the size and shape of the one or more slots may vary depending on the geometry of the aerosol-generating article and the shisha device. In this embodiments, the slots 95 also make the bottom wall 95 and the side wall 98 fluid permeable, such that air may be drawn through the aerosol-generating article 90 and into the heating unit 70 of the shisha device 50.

An advantage of providing the bottom wall and side wall of the aerosol-generating article with the material opaque to the RF electromagnetic field is that the number, size, shape and arrangement of the slots in the bottom wall and side wall may be chosen depending on the aerosol-forming substrate encased within the aerosol-generating article. The number, size, shape and arrangement of the slots in the bottom wall and side wall may influence the RF electromagnetic field within the aerosol-generating article, thereby influencing the heating of the aerosol-forming substrate and the temperature to which the aerosol-forming substrate is heated.

FIG. 7 shows a heating unit 70 for a shisha device and an aerosol-generating article 90 according to another embodiment of this disclosure. The heating unit 70 and aerosol-generating article 90 shown in FIG. 7 are substantially similar to the heating unit 70 and aerosol-generating article shown in FIG. 4, and like reference numerals are used to represent like features.

The heating unit 70 shown in FIG. 7 comprises an external housing 71, forming a cylindrical tube that is open at one end and substantially closed at the opposite end. The external housing 71 is formed from a material that is opaque to RF electromagnetic radiation.

An article cavity 14 is defined within the external housing 71 and is sized and shaped to receive the aerosol-generating article 90. The heating unit is arranged above the vessel 52 of the shisha device 50 by the airflow conduit 72, which extends into the substantially closed end of the external housing 71 of the heating unit 70 to fluidly connect the article cavity 14 to the vessel 52 of the shisha device 50. A radiation shielding element (not shown), in the form of a metal mesh, is provided in the airflow conduit 72 to prevent egress of the RF electromagnetic field from the article cavity 14 through the airflow conduit 72.

The heating unit 70 shown in FIG. 7 differs from the heating unit 70 shown in FIG. 4 in that the heating unit 70 shown in FIG. 7 comprises a closure 75. The closure 75 is moveable over the open end of the external housing 71 of the heating unit 70 to substantially close the open end. The closure 75 comprises an external housing similar to the external housing 71 of the heating unit, formed from the same material opaque to the RF electromagnetic field and sized and shaped to align and engage with the external housing 71 to close the open end. The closure 75 is rotatably connected to the external housing 71 by a hinge, and is rotatable between an open position, as shown in FIG. 7a, and a closed position, as shown in FIG. 7b. When the closure 75 is in the open position, the open end of the external housing 71 is open for insertion of an aerosol-generating article 90 into the article cavity 14, and for removal of the aerosol-generating article 90 from the article cavity 14. When the closure 75 is in the closed position, the article cavity 14 is surrounded by material that is opaque to the RF electromagnetic field, such that the RF electromagnetic field is unable to propagate from the article cavity 14.

In this embodiment, the closure 75 also comprises an electromagnetic field generator 11, in the form of a solid state RF LDMOS transistor, a wave guide 15 coupled to the output of the RF solid state transistor, a resonating cavity 80, and an antenna 16 coupled to the wave guide 16 and positioned in the resonating cavity 80. In this embodiment, the resonating cavity 80 comprises a substantially cylindrical body of dielectric material encased in a metallic outer container. The metallic outer container of the resonating cavity 80 comprises a pair of slots 79, which are provided to enable a RF electromagnetic field generated by the electromagnetic field generator 11 and directed into the resonating cavity 80 to propagate from the resonating cavity 80 into the article cavity 14 when the closure 75 is in the closed position. Control circuitry (not shown) and a battery (not shown) are also comprised in the closure 75 to provide a controlled supply of power to the electromagnetic field generator 11.

It will be appreciated that in some embodiments, the shisha device may comprise electrical components on the vessel 50 or on the mouthpiece 64 that require power from the battery, or control from the control circuitry. In these embodiments, a flexible circuit or wire may be provided from the control circuitry and battery in the enclosure 75, over the hinge to the components arranged at other locations on the shisha device 50.

In this embodiment, the closure 75 also comprises an air inlet (not shown), in the form of a fluid permeable region of material that is opaque to the RF electromagnetic field. The air inlet enables air to be drawn into the article cavity 14 when the closure 75 is in the closed position.

This embodiment has a particularly advantageous configuration in that is straightforward to manufacture, and comprises relatively few component parts. Furthermore, since the article cavity 14 is completely enclosed by material that is opaque to the RF electromagnetic field, the aerosol-generating article 90 is not required to have any external surfaces formed from a material opaque to the RF electromagnetic field. Since the aerosol-generating article 90 is typically a disposable component of the shisha system, this may reduce the cost of manufacture of the aerosol-generating article 90.

FIG. 8 shows a heating unit 70 for a shisha device 50 and an aerosol-generating article 90 according to another embodiment of this disclosure. The heating unit 70 and aerosol-generating article 90 shown in FIG. 8 are substantially similar to the heating unit 70 and aerosol-generating article 90 shown in FIG. 7, and like reference numerals are used to represent like features. FIG. 7a shows the heating unit 70 and the aerosol-generating article 90 before insertion of the aerosol-generating article 90 into an article cavity 14 of the heating unit 70. FIG. 7b shows the aerosol-generating article 90 received in the article cavity 14 of the heating unit 70.

The heating unit 70 shown in FIG. 8 differs from the heating unit 70 shown in FIG. 7 in that the heating unit 70 shown in FIG. 8 comprises the electromagnetic field generator 11, wave guide 15, antenna 60 and resonating cavity 80 in the external housing 71, rather than in the closure 75. In this embodiment, the closure 75 is merely a covering for closing the article cavity 14 to prevent egress of the RF electromagnetic field from the article cavity 14.

The resonating cavity 80 of the heating unit 70 shown in FIG. 8 comprises a substantially annular body of dielectric material encased in a metallic outer container. The resonating cavity 80 comprises a tapered inner passage that widens towards the open end of the external housing 71. In this embodiment, the inner passage of the resonating cavity 80 substantially defines the article cavity 14, being configured to receive the generally frustoconical aerosol-generating article 90. A plurality of slots 79 are provided in the metallic outer container of the resonating cavity 80, at the inner passage, to enable the RF electromagnetic field to propagate into the article cavity 14.

In this embodiment, the air flow path through the heating unit 70 is substantially longitudinal through the article cavity 14, in the direction of the airflow conduit 72, and the RF electromagnetic field propagates from the resonating cavity 80 into the article cavity 14 in a direction substantially transverse to the air flow. This arrangement ensures that the electromagnetic field generating apparatus is removed from the air flow pathway through the heating unit 70. This type of arrangement may make it easier to control the resistance to draw through the heating unit 70. This type of arrangement may also make management of the temperature of the electromagnetic field generating apparatus more straightforward, as the temperature of the electromagnetic field generating apparatus is less likely to fluctuate during use as a result of a user puffing on the device and drawing air over the electromagnetic field generating apparatus.

FIG. 9 shows a shisha system according to another embodiment of this disclosure. The shisha system is similar to the shisha system shown in FIG. 3, and like reference numerals are used to represent like features.

The shisha device 50 comprises a vessel 52 defining a liquid cavity 54, which is divided into two sections, a liquid section 56 comprising a volume of liquid, and a headspace 58 above the liquid section. In this embodiment, the vessel 52 is substantially cylindrical. A liquid fill level 60 is defined at the boundary between the liquid section 56 and the headspace 58, and is demarcated by a dashed line 60 on an external surface of the vessel 52. A headspace outlet 62 is provided on a side wall of the vessel 52, above the liquid fill level, and is configured to enable fluid to be drawn out of the liquid cavity at the headspace 58. A mouthpiece 64 is connected to the headspace outlet 62 by a flexible hose 66.

The vessel 52 is arranged on a heating unit 70, which in this embodiment is a cylindrical unit with a diameter substantially equal to that of the vessel 52. Accordingly, when the vessel 52 and heating unit 70 are arranged together for use, the shisha device 50 forms a substantially cylindrical unit.

The heating unit 70 is substantially similar to the heating unit shown in FIG. 7, and like reference numerals will be used to describe like features.

The heating unit 70 comprises an external housing 71 formed from a material that is opaque to RF electromagnetic radiation. The external housing 71 forms a cylindrical tube that is substantially closed at both ends. A door (not shown) is formed in a side wall of the external housing 71 and coupled to the side wall by a hinge. The door is rotatable between an open position and a closed position to allow aerosol-generating articles to be inserted into the heating unit 70 and removed from the heating unit 70. The door is lockable in the closed position to ensure that the door is not opened when the shisha device 50 is in operation, and the door is formed from a metal mesh that is opaque to RF electromagnetic radiation but is fluid permeable, such that ambient air can be drawn into the heating unit 70.

An article cavity 14 is defined in the heating unit 70 for receiving an aerosol-generating article 90. In this embodiment, the article cavity 14 is substantially frustoconical, such that the article cavity 14 is configured to receive a substantially frustoconical aerosol-generating article 90. The article cavity 14 is arranged above a resonating cavity 80. In this embodiment, the resonating cavity 80 comprises a substantially cylindrical body of dielectric material encased in a metallic outer container. The metallic outer container of the resonating cavity 80 comprises a pair of slots 79, which are provided to enable a RF electromagnetic field to propagate from the resonating cavity 80 into the article cavity 14.

An electromagnetic field generator 11, in the form of a solid state RF LDMOS transistor, is provided below the resonating cavity 80. The output of the electromagnetic field generator 80 is coupled to a wave guide 15, in the form of a waveguide. The wave guide 15 is arranged to direct a RF electromagnetic field generated by the electromagnetic field generator 11 to an antenna 16, which is arranged in the resonating cavity 80. With this arrangement, a RF electromagnetic field generated by the electromagnetic field generator 11 is directed to the resonating cavity 80, and propagates out of the resonating cavity 80, through the slots 79, into the article cavity 14 for heating an aerosol-forming substrate arranged in the article cavity 14. The electromagnetic field generator 11 is connected to control circuitry (not shown) and a lithium ion battery (not shown), which are arranged and configured to control the supply of power to the electromagnetic field generator 11 to control the RF electromagnetic field generated by the electromagnetic field generator 11.

An airflow conduit 72 extends from the article cavity 14 into the vessel 52, to a position in the liquid section 56, below the liquid fill level 60. The airflow conduit 72 fluidly connects the article cavity to the liquid section 56 of the vessel 52. To prevent liquid from the liquid section 56 flowing into the article cavity 14 through the airflow conduit 72 under the influence of gravity, a one way valve (not shown) is arranged in the airflow conduit 72 at the opening 73 between the heating unit 70 and vessel 52. The one way valve does not permit fluid to flow from the vessel 52 into the heating unit 70, and also requires a minimum pressure to be reached before fluid is able to flow from the heating unit 70 to the vessel 52.

In use, when a user draws on the mouthpiece 64, ambient air is drawn into the shisha device 50 through the mesh door (not shown) and into the article cavity 14. A puff sensor (not shown), provided in the article cavity 14 and connected to the control circuitry and battery, senses that a user is drawing on the mouthpiece 64 as air flows into the article cavity 14. When the puff sensor detects a user drawing on the mouthpiece 64, the control circuitry supplies power from the battery to the electromagnetic field generator 11, causing a RF electromagnetic field to propagate into the article cavity 14 and heat the aerosol-forming substrate in the aerosol-generating article 90. Volatile compounds are released from the heated aerosol-forming substrate. The air being drawn into the article cavity 14 entrains the released volatile compounds, and the entrained volatile compounds are drawn through the airflow conduit 72, through the one-way valve, into the liquid section 56 of the vessel 52. The volatile compounds cool in the volume of liquid in the liquid section 56, and are released from the liquid into the headspace 58, where they condense to form an aerosol. The aerosol is drawn out of the headspace 58 through the headspace outlet 62, along the hose 66 and to the mouthpiece 64 for inhalation by the user.

It will be appreciated that the embodiments described above are exemplary embodiments only, and various other embodiments according with this disclosure are also envisaged. For example, it will be appreciated that the heating unit embodiments described above may be used with any suitable design of shisha device, such as the devices shown in FIGS. 3 and 9. For example, it will also be appreciated that vessels, aerosol-forming articles and any other features of shisha systems according to this disclosure may be any other shape and size, as desired. For example, the liquid within the liquid sections of the shisha devices is preferably water, but may be another suitable liquid.

1.-15. (canceled)

16. A shisha device for heating an aerosol-forming substrate to generate an aerosol, the shisha device comprising:
a liquid cavity containing a volume of liquid through which aerosol generated by the shisha device is drawn before inhalation by a user, the liquid cavity having a head space outlet;
an article cavity configured to receive the aerosol-forming substrate, the article cavity being in fluid communication with the liquid cavity; and
an electromagnetic field generator configured to generate a radio frequency (RF) electromagnetic field in the article cavity, the electromagnetic field generator comprising a magnetron or a solid state RF transistor.

17. The shisha device according to claim 16,
wherein the electromagnetic field generator comprises the solid state RF transistor, and
wherein the solid state RF transistor is configured to generate and to amplify the RF electromagnetic field.

18. The shisha device according to claim 16,
wherein the article cavity comprises one or more external walls formed from a material opaque to the RF electromagnetic field, and
wherein one or more slots are formed in the one or more external walls.

19. The shisha device according to claim 16, wherein the article cavity comprises an open end configured to receive an aerosol-forming article comprising the aerosol-forming substrate, and a substantially closed end.

20. The shisha device according to claim 16, further comprising an antenna connected to the electromagnetic field generator and being configured to direct the RF electromagnetic field.

21. The shisha device according to claim 20, wherein the antenna is positioned at least partially in the article cavity.

22. The shisha device according to claim 16, further comprising a resonating cavity between the article cavity and the electromagnetic field generator.

23. The shisha device according to claim 16, further comprising a sensor in or adjacent to the article cavity, the sensor providing a signal indicative of a temperature in the article cavity, and a controller connected to receive the signal from the sensor and connected to control the electromagnetic field generator in dependence on the signal from the sensor.

24. A shisha system, comprising:
a shisha device according to claim 16; and
an aerosol-generating article comprising an aerosol-forming substrate.

25. The shisha system according to claim 24, wherein the aerosol-forming substrate comprises tobacco.

26. The shisha system according to claim 24, wherein the aerosol-generating article comprises one or more external surfaces formed from a material opaque to the RF electromagnetic field.

27. The shisha system according to claim 26, wherein one or more slots are formed in the one or more external surfaces formed from the material opaque to the RF electromagnetic field.

28. The shisha system according to claim 26, wherein the material opaque to the RF electromagnetic field forms a coating on the one or more external surfaces.

29. An aerosol-generating article for a shisha system, the aerosol-generating article comprising:
an aerosol-forming substrate; and
one or more external surfaces formed from a material opaque to an RF electromagnetic field,
wherein the material opaque to the RF electromagnetic field is fluid-permeable.

30. The aerosol-generating article according to claim 29, wherein the material opaque to the RF electromagnetic field is a metal mesh.
